(19) United States
(12) Patent Application Publication
(10) Pub. No.: US 2006/0039814 A1
(43) Pub. Date: Feb. 23, 2006

(54) Working unit of a rotary combustion engine

(75) Inventors: Wolfgang Baier, Euerbach (DE); Michael Schirmer, Zernsdorf (DE)

Correspondence Address: COHEN, PONTANI, LIEBERMAN & PAVANE, 551 FIFTH AVENUE, SUITE 1210, NEW YORK, NY, 10176, US

(73) Assignee: Wankel Super Tec GmbH

(21) Appl. No.: 11/186,709

(22) Filed: Jul. 21, 2005

(30) Foreign Application Priority Data
Jul. 21, 2004 (DE) 10 2004 035 418.9

(51) Int. Cl. F03C 2/00; F04C 2/00

(52) U.S. Cl. 418/61.2

(57) ABSTRACT

The invention pertains to a rotary combustion engine with at least one working unit, having essentially at least one peripheral housing, a terminal side plate, a side plate on the power takeoff side, and optionally at least one center housing, where a triangular piston in the working unit is mounted on an eccentric shaft and rotates around an epitrochoidal orbit, forming three working spaces, in which the combustion pressure produces high housing forces. To stabilize the working unit and to reduce the deformations caused by the pressures, the side plates, the peripheral housing, and optionally the center housing be welded together. In addition, reinforcement in the form of a binding element is used to further enhance the ability of the housing to withstand the housing forces and to realize components of smaller volume and lower weight.

### BACKGROUND OF THE INVENTION

1. Field of the Invention

The invention pertains to a rotary combustion engine with at least one working unit.

2. Description of the Related Art

In mass production of rotary combustion engines of the known design, a plurality of tie rods, which are parallel to the eccentric shaft of the engine and arranged outside the epitrochoidal orbit of the engine's combustion chamber at relatively short distances from each other, are used to seal off the working spaces from the outside. Before the housing parts are assembled, the eccentric shaft module and the piston module are laid in place, and then the tie rods are used to form a working unit by connecting the terminal side plate, the peripheral housing, and the side plate on the power takeoff side to each other along their flat surfaces, which are provided for this purpose. The hole pattern is, thus, the same for all three housing parts. When a center plate is used to build a rotary combustion engine consisting of two working units connected to each other, this hole pattern must also include the center plate. The bores which accommodate the tie rods increase the overall size of the unit, because they must be surrounded by housing material. This additional housing material takes space away from the water jacket, and the overall size of the unit must therefore be increased to compensate for the loss.

One disadvantage of this design is the increase in weight caused by the additional material around the bores and by the tie rods themselves. Another disadvantage is that the housing parts are held together along their flat surfaces by the friction produced by the pretension of the tie rods. In contrast to the parts of reciprocating engines, these parts must withstand the high shear forces which occur when high combustion pressures act on the epitrochoidal orbit and thus cause a housing force, acting in the radial direction.

A need, therefore, exists for providing a working unit for a combustion engine subject to high loads, with additional measures that are taken to control the housing forces caused by combustion. A further need exists for providing these measures so as to yield simultaneously savings in weight and advantages with respect to the design of the overall unit.

### SUMMARY OF THE INVENTION

As an elaboration of the previously described manner of assembling a rotary combustion engine, it is proposed that the housing parts of one working unit be welded together. When it is desired to build a rotary combustion engine with several working units, center plates are installed between pairs of peripheral housings, the plates and the housings being connected to each other along their flat surfaces as usual. Because each of the housing parts is in contact with the adjacent one by a flat surface, which is in a plane perpendicular to the eccentric shaft, it is possible to use the electron beam welding method under vacuum to make a weld in each of these plane, proceeding radially from the outside and into the flat surfaces. The process makes it possible to control the depth of the weld, so that the weld can extend up to a point close to the epitrochoidal orbit. A water jacket is provided around the epitrochoidal orbit. The radial dimension of this jacket is small, because there is no longer any need to provide areas of extra material around the bores. As a result, the overall size of the unit can be considerably reduced, and this also obviously means considerable savings in weight as well.

The welds cause almost no distortion of the housing parts, which means that the shapes of the flat surfaces of the side plates and of the surface lines of the epitrochoidal orbit are not changed. Before the welding operation, however, the module consisting of the piston with its set of teeth and sealing elements and the module consisting of the eccentric shaft and its bearings must be laid in place.

So that the various parts of the working unit of a rotary combustion engine can be assembled in mass production, it is necessary to use a process which can be divided into individual steps. An assembly and/or welding jig is used, into which one of the two side plates, such as the side plate on the power takeoff side, is first laid. The eccentric shaft with its bearings, forming one module, is then laid into the side plate fastened in the jig, namely, pushed into the bearing bores provided for this purpose, and the piston with its sealing elements is then pushed over the eccentric shaft. The peripheral housing can then be fitted around the piston and onto the power takeoff side plate. The working unit is then closed by the terminal side plate and prepared for the welding operation. In the case of a rotary combustion engine consisting of several working units, a center plate is first fitted onto the peripheral housing, to which the elements of a second working unit are then connected. Now the housing parts, all of which are lying next to each other in sandwich fashion, are clamped together in the axial direction and laid in an additional device designed to produce a vacuum around the working units. The side plates, the peripheral housing, and the optional center plate can now be welded together. Finally, the pretension required for the welding operation is released, and the working unit(s) is/are removed from the device. As indicated, it is also possible to increase the efficiency of the process by placing several working units into the additional device simultaneously, because it is advisable to produce as many welds as possible with a single evacuation.

To further improve the stability of the working unit, it is proposed that reinforcement in the form of a binding element be laid around the working unit to prevent the housing forces developed during combustion from negatively affecting the fatigue strength of the housing parts. The contour of the external surface of the rotary combustion engine would be made circular in the ideal case; at the very least, it should have a continuous curvature which is inward-directed at all points and which thus makes it possible to install a binding element which, after it has been installed under pretension, generates a certain contact pressure around the entire circumference of the contour. The contact pressure will be higher at points where the curvature of the contour is more pronounced and vice versa. If it is desired to have an especially high pretension act on a certain section of the contour, this can be achieved by reducing the radius of curvature in that section.

The binding elements of steel strip can have various forms, for which reason a second exemplary embodiment with a tightening band will be explained here. The binding element with a width which corresponds to the length of the working unit has several tongues at each end. These tongues at one end are offset from those at the other end, and the width of the intermediate spaces at one end is identical to the width of the tongues on the opposite end. In addition, the binding element has openings, which lie above channels, spark plugs, and similar elements important for supplying the working unit, so that the working unit can be connected to systems important for its operation outside the binding element.

The length of the binding element is calculated so that the tongues will engage with each other when the binding element has been wrapped around the contour of the working unit. To complete the reinforcement, another process is required by means of which the binding element can be given the required pretension. For this purpose, it is necessary to lay the working unit and the binding element together in a tensioning jig on a hydraulically operated machine. After the binding element has been laid around the working unit and arranged in the necessary position, the ends of the tongues can then be clamped. The binding element can now be pretensioned by applying tensile force to the ends of the tongues in opposite directions in a common tangential direction. The tongues are also wrapped around a certain angle so that gaps extending in the circumferential direction are produced between adjacent tongues, these gaps being of sufficient length for the production of good welds. After the tongues have been welded together along their adjacent, arc-shaped edges, the tensioning jig can be released. The working unit and the binding element now form a single structural unit and can be removed together. The ends of the tongues are now bent into their throats and welded in place there, if necessary. Finally, it has been found that the visual appearance of the structural unit can be enhanced in the area of the welds by a grinding operation. It will be appreciated that the rotary combustion engine described herein can be used in motor vehicles.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

A rotary combustion engine with reinforcement is explained below on the basis of seven diagrams:

FIG. 1 shows longitudinal cross section of a rotary combustion engine consisting of two working units with a terminal side plate, two peripheral housings, a center housing, a piston, and an eccentric shaft, the housing parts being welded together;

FIG. 2 shows a plan view of the piston and the peripheral housing with channels;

FIG. 3 shows the arrangement of the channels in the rotary combustion engine;

FIG. 4 shows a developed view of a binding element with tongues for reinforcing the working unit;

FIG. 5 shows the binding element in position around the working unit and the position of the tongues for producing the pretension;

FIG. 6 shows the binding element around the working unit with welds along the tongues; and

FIG. 7 shows the reinforcement of a working unit with a tightening band as an alternative to the reinforcement by means of a binding element.

### DETAILED DESCRIPTION OF THE PRESENTLY PREFERRED EMBODIMENTS

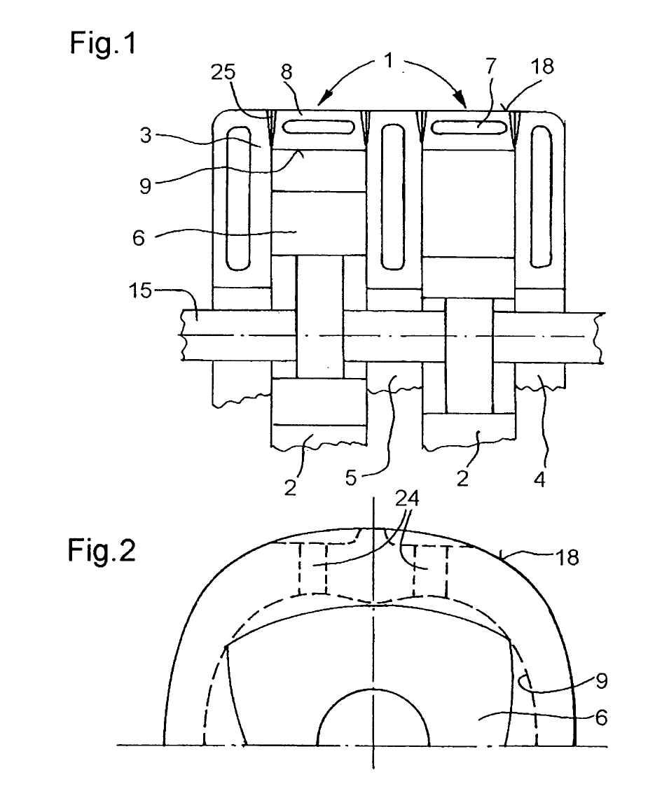

In FIG. 1, a working unit is designated by the reference number 1. The rotary combustion engine shown here consists of two of these working units 1, which are connected to each other by way of a center housing 5. The housing parts are, specifically, a terminal side plate 3, a peripheral housing 2, the center housing 5, and a side plate 4 on the power takeoff side. To assemble the working unit 1, it is also necessary to lay an eccentric shaft 15 and a piston 6 in place, which represent preassembled modules. The housing parts, which are joined together along their flat surfaces, are connected by welds 25, which are produced by the electron beam welding method and which reach a depth which brings them to a point very close to the epitrochoidal orbit 9. The welds 25 are produced in a special jig under vacuum and proceed from the external contour 18 of the working unit 1 and continue in the plane of the flat surfaces radially inward to a point close to the epitrochoidal orbit 13. A water jacket 7 and an outer housing part 8 of the housing 2 forming one of the jacket's boundaries are thus stabilized with respect to the side plates 3, 4 and with respect to the center housing 5, as a result of which the strength of the working unit is enormously increased, and the radial dimension of the water jacket 7 can be kept small.

FIG. 2 shows the location of the channels 24 and the position of the piston 6 inside the epitrochoidal orbit 13. The course of the contour 18 and its approximate curvature can also be seen.

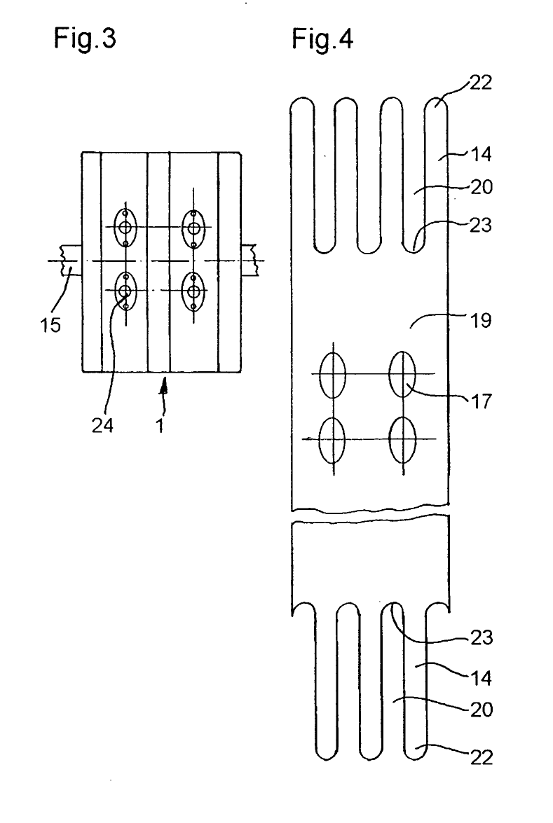

FIG. 3 shows the double working unit 1, two channels 24 being provided in each of the two peripheral housings 2.

FIG. 4 shows a binding element 19 which, in this exemplary embodiment, has the width of the double working unit 1 and accordingly also has four openings 17, which line up with the channels 24 of FIG. 3. Additional openings can/must be provided, one for the spark plug, for example, of which each peripheral housing 2 has at least one. To define its length, the binding element 19 also has at least two tongues 14 at each end. The tongues have ends 22 at the outer part, intermediate spaces 20, and throats 23 at their base. The binding element 19 consists of steel strip material thick enough to ensure that sufficient pretension can be achieved when it is installed.

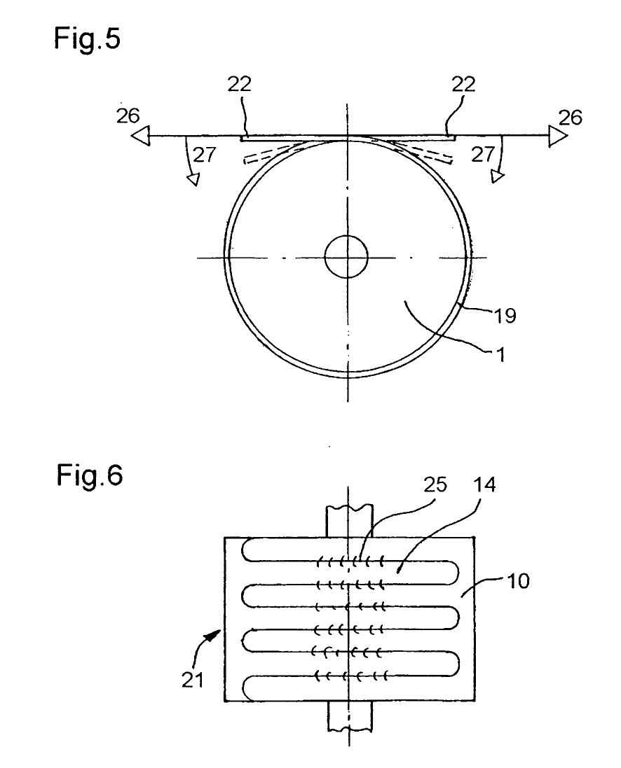

FIG. 5 shows the working unit 1 after the binding element 19 has been put in place. One can see the ends 22, which are subjected to tensile force in a tension direction 26 in order to produce a circumferential and radially inward-directed pretension in the housing parts. To hold the binding element 19 in place, however, welds 25 must also be applied, which cannot be produced until after the tongues 14 have been turned inward around the angle 27.

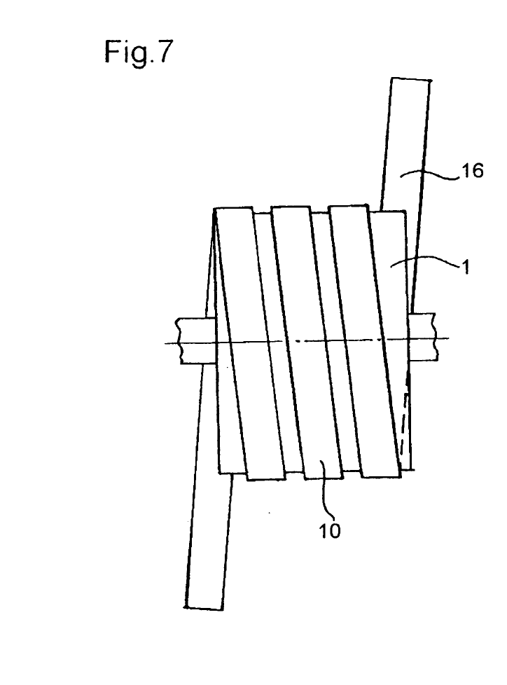

The result is shown in FIG. 6, which illustrates how the structural unit 21 consisting of a working unit 1 and a binding element 19 is provided with the reinforcement 10 by the production of the welds 25, which extend in the circumferential direction along the common edges of the intermeshing tongues 14.

As shown in FIG. 7, a tightening band 16 has been wrapped as reinforcement 10 around a working unit 1, and the ends have been fastened under pretension. This represents an alternative to the previously described reinforcement 10 of the working unit 1 by means of the binding element 19.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A working unit of a rotary combustion engine having an eccentric shaft, comprising:
a peripheral housing;
a first side plate and a second side plate flanking the peripheral housing; and
a triangular piston mounted to the eccentric shaft and rotatable around a peritrochoid orbit within the peripheral housing so as to define a plurality of working spaces therein, the first and second side plates and the peripheral housing being permanently connected to one another.

2. The working unit of claim 1, further comprising at least one additional peripheral housing spaced from the peripheral housing along a shaft axis, and a center housing between the peripheral housings, wherein the first and second side plates, the peripheral housings and the center housing are permanently connected to one another.

3. The working unit of the rotary piston internal engine of claim 1, wherein the first and second side plates are welded to the peripheral housing.

4. The working unit of claim 1, wherein the first and second side plates are welded to the peripheral housing by an electron beam under vacuum.

5. The working unit of claim 1, wherein the peripheral housing and the first and second side plates have respective flat surfaces facing one another, each pair of adjacent flat surfaces being welded together by a respective weld extending inwardly from an outer peripheral surface of the peripheral housing and first and second side plates.

6. The working unit of claim 5, wherein the weld has a depth extending substantially to a level of the peritrochoid orbit.

7. A working unit of a rotary combustion engine having an eccentric shaft, comprising:
a peripheral housing;
spaced side plates flanking the peripheral housing;
a triangular piston mounted to the eccentric shaft and rotatable within the peripheral housing around a peritrochoid orbit so as to define a plurality of working spaces in the peripheral housing, wherein the peripheral housing and the side plates each have respective outer periphery; and
a reinforcement unit surrounding the outer periphery of the peripheral housing and the side plates including regions thereof affected by high housing forces which are generated by combustion pressures in the plurality of working spaces.

8. The working unit of claim 7, further comprising a center housing coupled to the peripheral housing, and an additional peripheral housing mounted between the center housing and one of the side plates, wherein the side plates, the peripheral housings and the center housing define two subworking units of the combustion engine.

9. The working unit of claim 7, wherein one of the side plates is a terminal plate, and the other side plate is located on a power takeoff side.

10. The working unit of claim 7, wherein the outer periphery of the peripheral housing and the side plates is substantially convex.

11. The working unit of claim 7, wherein the reinforcement unit has a binding element mounted under pretension around the outer periphery of the peripheral housing and the side plates.

12. The working unit of claim 11, wherein the binding element has engaging components welded to one another while the binding element is being pretensioned.

13. The working unit of claim 11, wherein the binding element has a plurality of tongues offset from one another so as to engage one another upon placing the binding element around the outer periphery.

14. The working unit of claim 13, wherein the plurality of tongues each have a contact surface juxtaposed with a contact surface of an adjacent tongue and extending circumferentially along the outer periphery of the peripheral housing and the side plates while the binding element is being pretensioned, the contact surfaces being welded together upon engagement of the tongues.

15. The working unit of claim 7, further comprising a plurality of cooling channels and spark plugs formed on the outer periphery, the reinforcement unit being provided with a plurality of openings configured to provide access from outside to the plurality of cooling channels and spark plugs.

16. The working unit of claim 8, wherein the reinforcement unit comprises a single binding element laid around the two subworking units.

17. The working unit of claim 8, wherein the reinforcement unit comprises two separate binding elements laid around the respective subworking units.

18. The working unit of claim 7, wherein the reinforcement unit has a tightening band wrapped under pretension around the outer periphery of the side plates and the peripheral housing.

19. A process for assembling at least one working unit of a rotary combustion engine, the process comprising the steps of:
placing a first side plate in an assembly;
providing a first preassembled module comprising an eccentric shaft and mounting one end thereof to the first plate;
providing a second preassembled module having a rotary piston and mounting the piston to the eccentric shaft;
fitting a peripheral housing around the rotary piston;
mounting a second side plate to the eccentric shaft, thereby having the first and second side plates flank the peripheral housing so as to form a first subunit;
clamping the peripheral housing and the first and second side plates together along an axis of the eccentric shaft so as to apply a force pretensioning the first subunit;
placing the first subunit in vacuum;
welding the peripheral housing to the first and second side plates; and
removing the first subunit from the device upon releasing the force.

20. The method of claim 19, further comprising sequentially mounting an additional peripheral housing next to the first side plate and a center housing next the additional peripheral housing before fitting the peripheral housing around the piston, thereby forming a plurality of subunits.

21. The method of claim 19, wherein the assembly comprises a welding jig, the first side plate being located on a power takeoff side of the combustion engine.

22. A process for reinforcing at least one working unit of a rotary combustion engine, the at least one working unit comprises a peripheral housing, a terminal side plate and a side plate on a power takeoff side spaced from the terminal side so that the peripheral housing is flanked by the side plates, an eccentric shaft extending through the terminal side plate, the peripheral housing and the side plate, the process comprising the steps of:
placing the at least one working unit in a clamping jig on a hydraulically operated machine;
pushing a preformed binding element onto a periphery of the working unit, the preformed binding element comprising a plurality of tongues;
clamping ends of the plurality of tongues into the hydraulic machine;
applying a tensile force to the plurality of clamped tongues so that the tongues are pulled toward one another in a common tangential direction to a periphery of the working unit and wrapped thereabout at an angle;
welding the plurality of tongues to one another along adjacent curved edges thereof;
releasing the tensile force; and
removing the working unit from the clamping jig.

23. The process of claim 22, wherein the welding of the plurality of tongues comprises welding the ends of the tongues at respective throats.

24. The process of claim 22, further comprising cleaning of the removed working unit.

25. A rotary combustion engine comprises at least one working unit of claim 1.

26. A rotary combustion engine comprises the at least one working unit of claim 7.

27. A motor vehicle comprising the rotary combustion engine of claim 25.

28. A motor vehicle comprising the rotary combustion engine of claim 26.

29. A rotary combustion engine comprises a plurality of identical working units of claim 7, wherein each working unit has a binding element laid around a periphery of the respective working unit.

30. A rotary combustion engine comprises a plurality of identical working units of claim 7, wherein the plurality of working units has a single binding element laid around a periphery of the plurality of working units.
